(19) United States
(12) Patent Application Publication
(10) Pub. No.: US 2006/0288197 A1
(43) Pub. Date: Dec. 21, 2006

(54) Identifying an operating system associated with a boot path

(76) Inventors: Robert C. Swanson, Olympia, WA (US); Mallik Bulusu, Olympia, WA (US); Vincent J. Zimmer, Federal Way, WA (US); Michael A. Rothman, Puyallup, WA (US); Matthew E. Tolentino, Columbia, SC (US)

Correspondence Address: TROP PRUNER & HU, PC, 1616 S. VOSS ROAD, SUITE 750, HOUSTON, TX, 77057-2631, US

(21) Appl. No.: 11/154,320

(22) Filed: Jun. 16, 2005

(51) Int. Cl. G06F 15/177

(52) U.S. Cl. 713/1

(57) ABSTRACT

Various characteristics of a hard drive may be analyzed in order to determine the nature of an operating system stored thereon. For example, an operating system indicator and/or a boot record may be identified which may enable operating system identification. Alternatively, checksums may be used to disambiguate the stored operating system. Other disk characteristics may be utilized to enable a determination of operating system and operating system version. This information may be provided to the user in a graphical user interface indicating the correspondence between operating systems and drives, or a desired operating system, once identified, may be automatically used without analyzing all drives.

### BACKGROUND

This invention relates generally to booting processor-based systems.

Generally, when a processor-based system, such as a computer or a server, is booted, an operating system must be selected. Where only one drive, storing one operating system, is present, this is a relatively simple task.

However, in some cases, such as in connection with servers, there may be a large number of drives and a large number of potential bootable operating systems. The user may then wish to determine a specific operating system with which to initially operate the computer system. To do so, the user must figure out on what drive the desired operating system resides.

Often times, the legacy infrastructure that populates the master boot record (MBR) is replaced by the last installed operating system. The purpose behind the contents of the MBR is to launch the active boot target, or in the case of more advanced operating system infrastructures, to present a selection of choices to support multiple boot targets.

Many operating systems will populate the MBR with proprietary knowledge of their own operating system targets and the MBR may be relatively obscure regarding other targets.

The basic input/output system displays a listing of boot devices found and allows the user to choose which one to be the primary boot device. The only information about these boot options that is given may be the name of the physical hard disk. If the user chooses a disk that contains a partition, but not a valid operating system image, the boot will fail and the user will see a boot failure message on the screen. If the user selects a hard drive with a valid operating system image, then the user will boot to that image. If the user intended to boot to another operating system, the user will have to reset the system and try again.

### BRIEF DESCRIPTION OF THE DRAWINGS

FIG. 1 is a depiction of a system architecture in accordance with one embodiment of the present invention;

FIG. 2 is a flow chart for a basic input/output system software in accordance with one embodiment of the present invention;

FIG. 3 is a hypothetical screen display in accordance with one embodiment of the present invention;

FIG. 4 is a flow chart for predictive boot software which may be called by the software presented by flow chart of FIG. 2 in accordance with one embodiment of the present invention;

FIG. 5 is a flow chart for selective BIOS execution software which may be called by the software shown in FIG. 4 in accordance with one embodiment of the present invention; and

FIG. 6 is a schematic depiction of one embodiment of the present invention.

### DETAILED DESCRIPTION

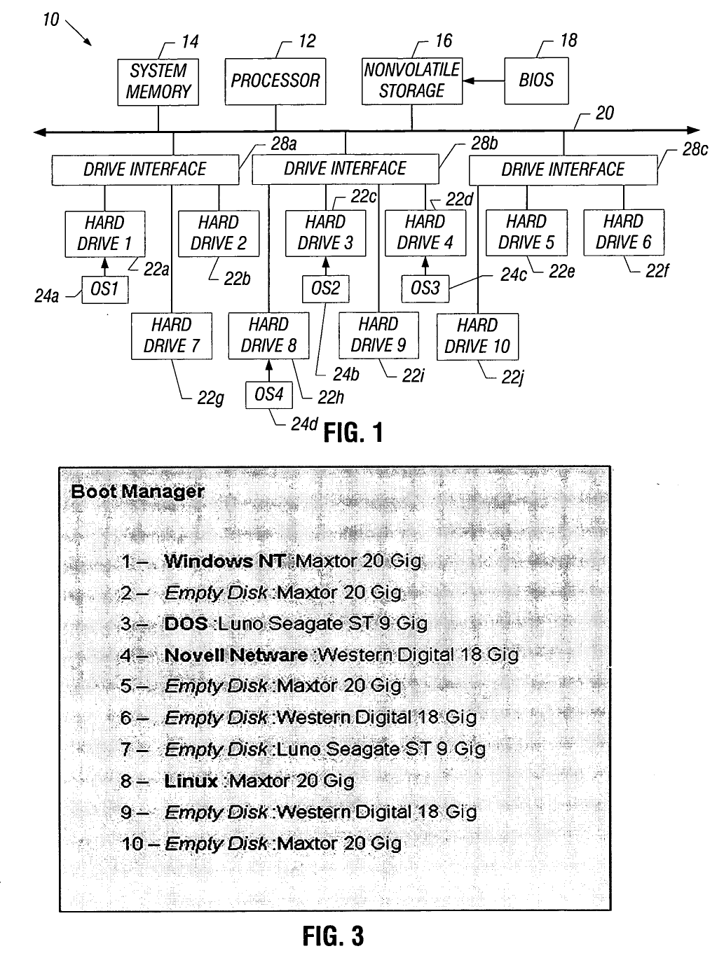

Referring to FIG. 1, a processor-based system 10 may, for example, be a server, a high-end work station or a distributed system. It may include a processor 12 that may be one of multiple processors. The processor 12 may be coupled, by a bus 20, to a non-volatile storage 16 that stores a basic input/output system (BIOS) 18 in one embodiment of the present invention. A system memory 14 may also be coupled to the bus 20.

A plurality of drive interfaces 28a-28c are shown in one exemplary embodiment of the present invention. Each of the drive interfaces 28 may be an appropriate interface for one or more hard drives 22 coupled thereto. For example, in one embodiment, the drive interfaces 28a-c may be a small computer system interface (SCSI). However, any other interface associated with drives may also be utilized.

The drive interface 28a supports the hard drives 22a, 22b, and 22g. The drive interface 28b supports the drives 22c, 22d, and 22i. The drive interface 28c supports the drives 22e, 22f, and 22j. Of course, a variety of other arrangements of the drives and drive interfaces may be contemplated by those skilled in the art.

Some of the drives, such as the drives 22a, 22c, 22d, and 22h, have operating systems stored thereon. The operating systems 24a-24d may, in this example, all be different. A user who wants to boot, for example, with the operating system 24d, needs a way to know which hard drive has the operating system 24d stored thereon.

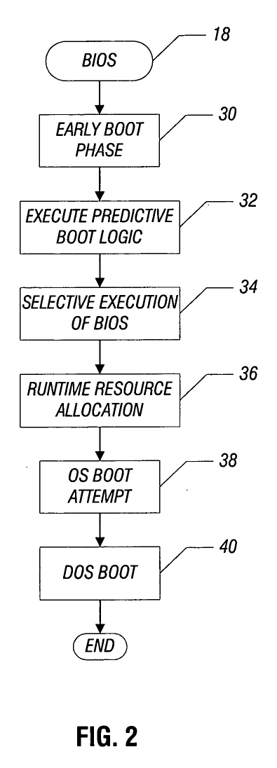

In accordance with one embodiment of the present invention, the basic input/output system software. 18, shown in FIG. 2, begins with an early boot phase 30. In some embodiments of the present invention, the early boot phase 30 may be conventional in all respects.

At an appropriate point, the predictive boot logic software 32 may be executed. The predictive boot logic software 32 enables the system 10 to determine which operating systems may be stored on which hard drives.

In one embodiment, the predictive boot logic software 32 may display a graphical user interface, such as the one shown in FIG. 3, indicating which drives store which operating systems. In other embodiments, the predictive boot logic software 32 may find a particular operating system, which the user desires to use, and may automatically boot using that user selected operating system.

In the exemplary graphical user interface shown in FIG. 3 hard drive 1 (drive 22a in FIG. 1) stores OS1 24a which happens to be Windows NT. The hard drive 22a is also indicated to be a Maxtor brand 20 gigabyte drive. The drive 2 (drive 22b) is indicated to be an empty disk, but is a Maxtor 20 gigabyte drive. The drive 3, indicated as 22c in FIG. 1, is a Luno Seagate ST 9 gigabyte drive with a disk operating system (DOS) stored thereon.

Thus, the graphical user interface shown in FIG. 3 may be configured automatically and automatically displayed for the user in some embodiments. In such an embodiment, the user can then select which of the drives the user wants to boot from, based on the operating system stored thereon. In some embodiments, the various drive names indicated in the graphical user interface, may be hot clickable so that the user can simply mouse click on the drive that the user wishes to use initially and that operating system will automatically be booted.

Returning to FIG. 2, after the selective execution of the BIOS (block 34) for the desired drive/operating system, the run time resource allocation continues as indicated in block 36. Then, an operating system boot attempt is implemented, as indicated in block 38, followed by the disk operating system boot in block 40.

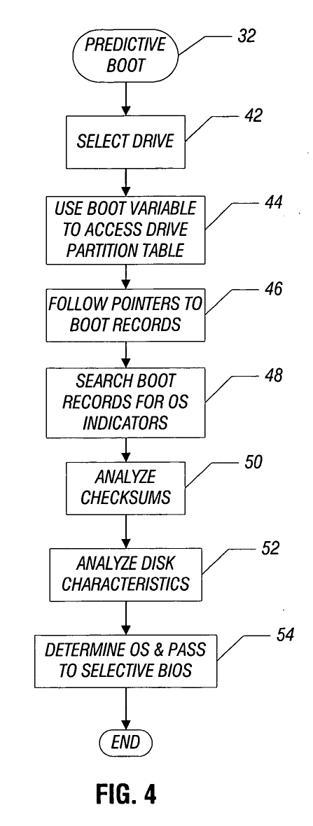

Now referring to FIG. 4, the predictive boot software 32, called from the flowchart of FIG. 2, begins by selecting a drive to analyze. For example, in a default system, the first hard drive may be selected to analyze first (block 42). In order to analyze that drive, a boot variable may be identified (block 44) to access a drive partition table. The boot variable enables a disk partition table to be located on a particular hard drive that was selected for analysis. In the partition, the first data sector may be defined. At the logical block address location of the first data sector, is a boot record. The partition table pointers points to master boot records in various partitions on the drive. These pointers may be followed to the boot records as indicated in block 46. Then, the boot records may be searched for operating system indicators as indicated in block 48. Operating system indicators may be indicators provided in the boot records which indicate which operating system is actually stored thereon. The operating system indicator is conventionally the fifth byte in the MBR partition table.

In some cases, the operating system indicators may be insufficient to disambiguate a particular drive and to identify its operating system. In such case, various checksums may be analyzed, as indicated in block 50. The checksum of the boot record sometimes directly relates to a specific version of an operating system. For example, the checksum may disambiguate between Windows® 95 and Windows® 95 service release 2. The same approach can be applied to disambiguate boot records which are formatted in accordance with a variety of operating systems. In such case, the software 32 may access a database of known checksums so that it can further disambiguate otherwise similar operating systems. The BIOS can fingerprint the boot record for a given operating system by calculating a checksum value, comparing that value to a reference, valid value, so that the type of operating system may be determined.

Next, if the checksum and the operating system indicators are still not sufficient or, in other cases, to further disambiguate versions or other variables, disk characteristics may be analyzed as indicated in block 50. A variety of disk characteristics may be analyzed to attempt to determine the version of the operating system. For example, with some versions of Linux, such as RHEL4, it may be difficult to determine which operating system version is provided because the operating system indicator does not identify an operating system version. However, partitions for Red Hat are indicative of what Linux version, because the partitions have a unique arrangement which is indicative of the particular Linux version. For example, the standard installation package partition layout may be indicative of the Linux version. In some embodiments, a list of characteristics may be provided in the source code for the software 32 which may be analyzed to determine which Linux version is implicated. Based on this information, the particular Linux version may be identified.

Finally, the various disk characteristics, checksums, and operating system characteristics may be analyzed to determine the particular operating system and disk drive as indicated in block 52. The operating system may be determined and this information may be passed to the selected BIOS software as indicated in block 54.

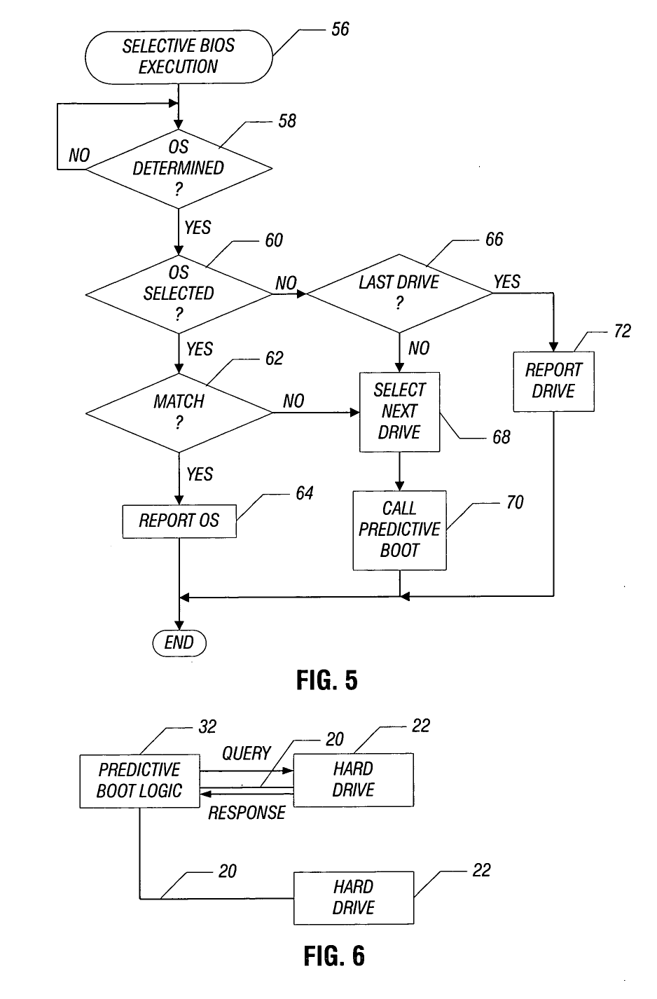

Turning to the selective BIOS execution software 56, shown in FIG. 5, called from the flowchart of FIG. 2, a check at diamond 58 determines whether the operating system has been determined. If so, a check at diamond 60 determines whether the user has selected a particular operating system. If so, a check at diamond 62 determines whether the drive that was analyzed stores an operating system that matches the operating system that was selected by the user. If so, the operating system may be identified to the user. Thus, in block 64, the user may simply be advised which drive has that operating system or, in another embodiment, the booting process may proceed with that operating system automatically.

If no operating system is selected, a check at diamond 66 determines whether the last drive of all the drives on board has been analyzed. If so, the drive that is just identified is added to the report, such as the one shown in FIG. 3, which may, in some embodiments, be displayed for the user as indicated in block 72. If the last operating system has not then be analyzed, as determined in diamond 66, the next drive is selected as indicated in block 68.

Similarly, if an operating system was selected by the user, as determined by diamond 60, and a match between the drive that was just analyzed and the operating system the user selected was not found (diamond 62), the next drive is selected, as indicated in block 68, and the predictive boot software 32 is called, as indicated in block 70, to analyze the next drive.

Thus, in some embodiments of the present invention, it may be necessary to access fewer than all of the drives before the user selected operating system and corresponding drive is identified. Since it may take some amount of time to access each of a large number of drives, the drive that the user wants may be identified and used immediately. In another embodiment, the characteristics of particular drives may be displayed in a graphical user interface, such as that shown in FIG. 3, as they are determined so that, if the operating system that the user is seeking appears on that interface, the user can go ahead and select that drive, terminating the ongoing analysis of drive after drive.

Referring to FIG. 6, in accordance with another embodiment of the present invention, the predictive boot logic 32 may be implemented as software running on the processor 12 or as firmware or hardware. In this embodiment, the predictive boot logic 32 communicates with at least two hard drives 22 over a connection which, in one embodiment, may be the bus 20. The predictive boot logic queries a hard drive 22, as indicated in FIG. 6, and receives a response from that hard drive. The response may include information which enables the predictive boot logic 32 to determine the nature of the operating system stored therein. Examples of the types of information that may be utilized have already been described herein.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. a method comprising:
analyzing a characteristic of a hard drive to identify an operating system stored thereon.

2. The method of claim 1 wherein analyzing a characteristic includes automatically analyzing a series of hard drives to determine the operating system stored thereon.

3. The method of claim 1 including searching for operating system indicators in boot records to identify the operating system stored on a drive.

4. The method of claim 1 wherein analyzing a characteristic of a hard drive includes analyzing a checksum.

5. The method of claim 4 wherein analyzing a checksum includes calculating a checksum value and comparing that value to a reference value to determine the type of operating system.

6. The method of claim 1 wherein analyzing a characteristic of a hard drive includes analyzing an installation package partition to determine a Linux version.

7. The method of claim 1 including displaying a graphical user interface showing hard drives and the operating systems stored thereon.

8. The method of claim 1 including automatically locating a particular operating system which a user has selected.

9. The method of claim 8 including terminating the analysis of hard drives when the selected operating system is identified.

10. The method of claim 1 including automatically analyzing one drive after another of a plurality of hard drives on a processor-based system to determine the operating system stored on each hard drive.

11. An article comprising a medium storing instructions that, if executed, enable a processor-based system to:
analyze a characteristic of a hard drive to identify an operating system stored thereon.

12. The article of claim 11 further storing instructions that, if executed, enable the processor-based system to automatically analyze a series of hard drives to determine the operating systems stored thereon.

13. The article of claim 11 further storing instructions that, if executed, enable the processor-based system to search for operating system indicators in boot records to identify the operating system stored on a drive.

14. The article of claim 11 further storing instructions that, if executed, enable the processor-based system to analyze a checksum to identify an operating system.

15. The article of claim 14 further storing instructions that, if executed, enable the processor-based system to calculate a checksum value and compare that value to a reference value to determine the type of operating system.

16. The article of claim 11 further storing instructions that, if executed, enable the processor-based system to analyze an installation package partition to determine a Linux version.

17. The article of claim 11 further storing instructions that, if executed, enable the processor-based system to display a graphical user interface showing hard drives and the operating systems stored thereon.

18. The article of claim 11 further storing instructions that, if executed, enable the processor-based system to automatically locate a particular operating system which a user has selected.

19. The article of claim 18 further storing instructions that, if executed, enable the processor-based system to terminate the analysis of hard drives when the selected operating system is identified.

20. The article of claim 11 further storing instructions that, if executed, enable the processor-based system to automatically analyze one drive after another of a plurality of hard drives on the processor-based system to determine the operating system stored on each drive.

21. A system comprising:
predictive boot logic;
at least two hard drives coupled to said logic; and
said logic to analyze information associated with said hard drives to identify an operating system stored thereon.

22. The system of claim 21 wherein said system is a server.

23. The system of claim 21 including a series of hard drives and said logic to automatically analyze said series of hard drives to determine the operating systems stored thereon.

24. The system of claim 21, said logic to search for operating system indicators and boot records to identify the operating systems stored on said drives.

25. The system of claim 21 wherein said logic to analyze a checksum.

26. The system of claim 24 wherein said logic to calculate a checksum value and compare that value to a reference value to determine a type of operating system.

27. The system of claim 21 wherein said logic to analyze an installation package partition to determine a Linux version.

28. The system of claim 21 including a display to display a graphical user interface showing the hard drives and the operating systems stored thereon.

29. The system of claim 21, said logic to automatically locate a particular operating system which a user has selected.

30. The system of claim 29 wherein said logic to terminate the analysis of hard drives when the selected operated system is identified.
